(19) United States
(12) Patent Application Publication
(10) Pub. No.: US 2007/0166124 A1
(43) Pub. Date: Jul. 19, 2007

(54) Screw with ridges and grooves between threads on shank

(76) Inventor: Kuo-Tai Hsu, Yong Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/331,151

(22) Filed: Jan. 13, 2006

(51) Int. Cl. F16B 25/10

(52) U.S. Cl. 411/387.1

(57) ABSTRACT

A screw includes a head and a shank which includes a tip end. Spiral threads are defined in an outer periphery of the shank which includes a first section including the tip end and a second section including the head. A plurality of cutting ridges extend from the outer periphery of the first section of the shank so as to cut the fibers of the object and remove the debris of the object upward. The second section includes a plurality of grooves defined in the shank so as to receive the debris to prevent the debris from breaking the object.

### FIELD OF THE INVENTION

The present invention relates to a screw having cutting ridges on the first section including the tip end and grooves on the second section so as to efficiently penetrate through the object and remove the debris of the object.

### BACKGROUND OF THE INVENTION

A conventional screw generally includes a head and a shank with spiral threads defined in the shank. A tip end is defined in an end opposite to the head so that the screw penetrates into the object by the tip end and the threads cut the fibers of the object to let the screw move into the object. However, it is experienced that if the object is a hard object then the users have to apply a huge force to push and rotate the screw. This not only requires a lot of physical efforts and also increases the operation time. After the tip end of the screw enters into the object, the screw is rotated and the threads cut the fibers of the object. The debris of the object cannot be removed within the small space and the object could be broken by the accumulated debris. Besides, U.S. Pat. No. 6,789,991 and U.S. Pat. No. 6,056,491 disclose two screws which are known to applicant.

The present invention intends to provide an improved screw which includes a first section including the tip end and a second section. The first section includes cutting ridges between the threads on the shank so as to remove the debris upward, and the second section includes grooves defined in the shank so as to receive the debris. The screw of the present invention efficiently screws into the objects.

### SUMMARY OF THE INVENTION

The present invention relates to a screw that comprises a head and a shank connected to the head. A tip end is defined in an end of the shank and located opposite to the head. Spiral threads are on an outer periphery of the shank. The shank includes a first section and a second section including the head. The first section includes the tip end and a plurality of cutting ridges extend from the outer periphery of the first section of the shank. The second section includes a plurality of grooves defined in the shank.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the screw of the present invention;

FIG. 2 is a perspective view to show the screw of the present invention;

FIG. 2-1 shows an enlarged view of the first section of the screw;

FIG. 2-2 shows an enlarged view of the second section of the screw;

FIG. 3 shows the two respective cross sectional view screws of the first section and the second section of the screw of the present invention;

FIG. 4 shows the first section of the screw penetrates into an object;

FIG. 5 shows the second section of the screw penetrates into an object, and

FIG. 6 shows another embodiment of the screw of the present invention.

### DETAILED DESCRIPTION OF THE PREFERRED EMBODIMENT

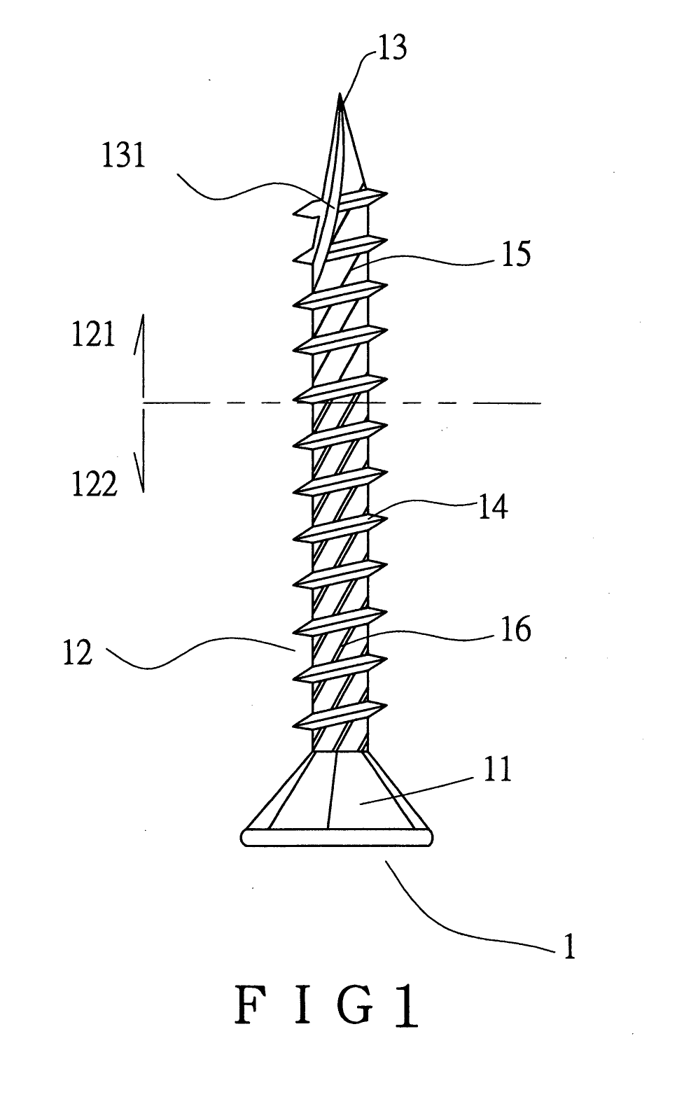

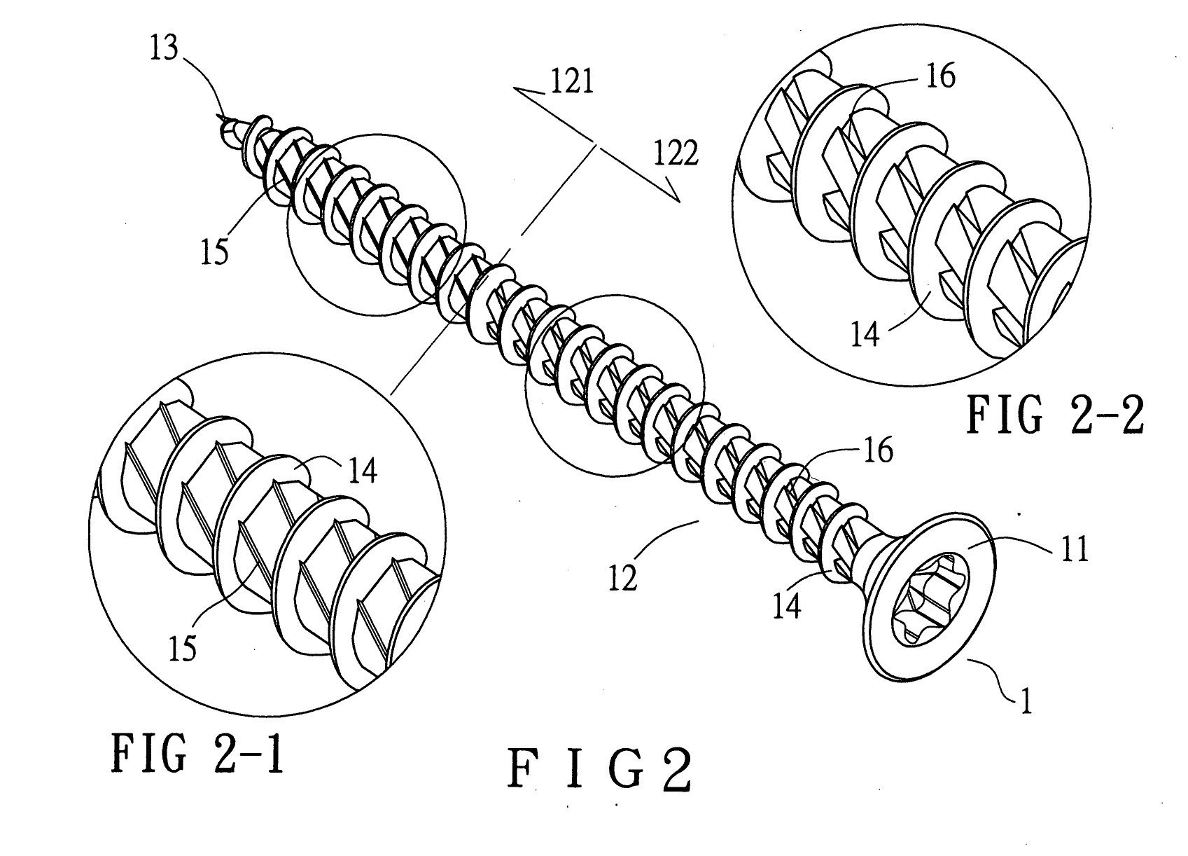

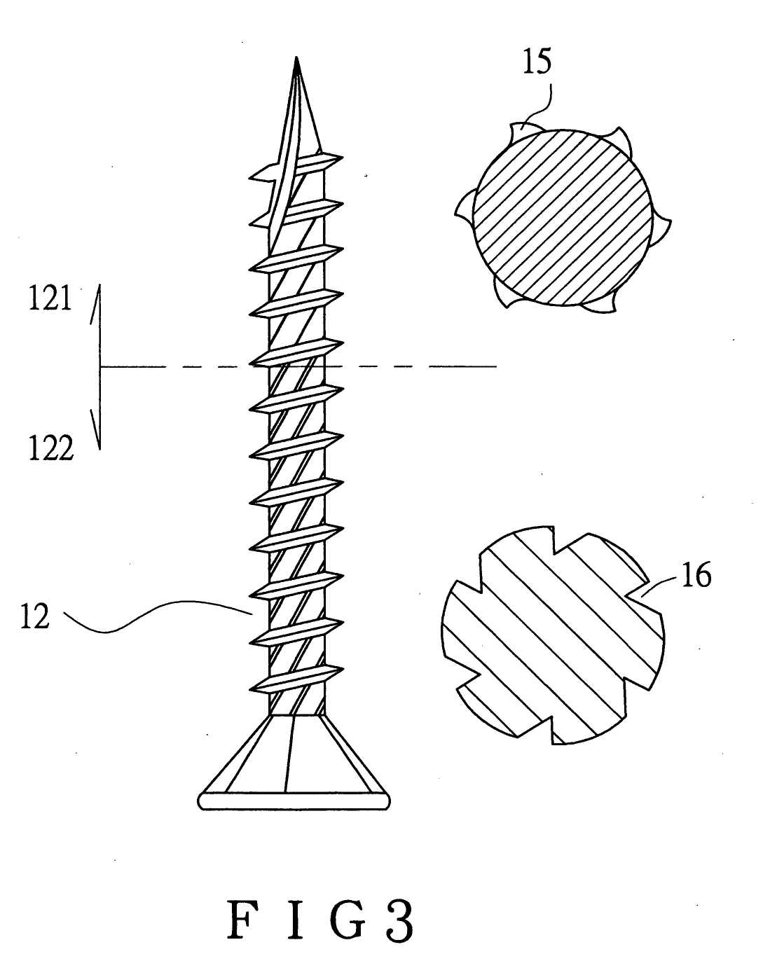

Referring to FIGS. 1, 2, 2-1, 2-2 and 3, the screw 1 of the present invention comprises a head 11 and a shank 12 is connected to the head 11. A tip end 13 is defined in an end of the shank 12 and located opposite to the head 11. Spiral threads 14 are defined in an outer periphery of the shank 12. At least one cutting groove 131 is defined in an outer periphery of the tip end 13.

The shank 12 includes a first section 121 including the tip end 13 and a second section 122 which includes the head 11. The first section 121 includes a plurality of cutting ridges 15 extending from the outer periphery of the first section 121 of the shank 12. The cutting ridges 15 are located between the spiral threads 14 and are tilt relative to an axis of the shank 12. The cutting ridges 15 each are an inverted V-shaped ridge which includes a cutting edge. The second section 122 includes a plurality of grooves 16 defined in the shank 12 and the grooves 16 are located between the spiral threads 14. The grooves 16 each are a V-shaped groove and tilt relative to an axis of the shank 12.

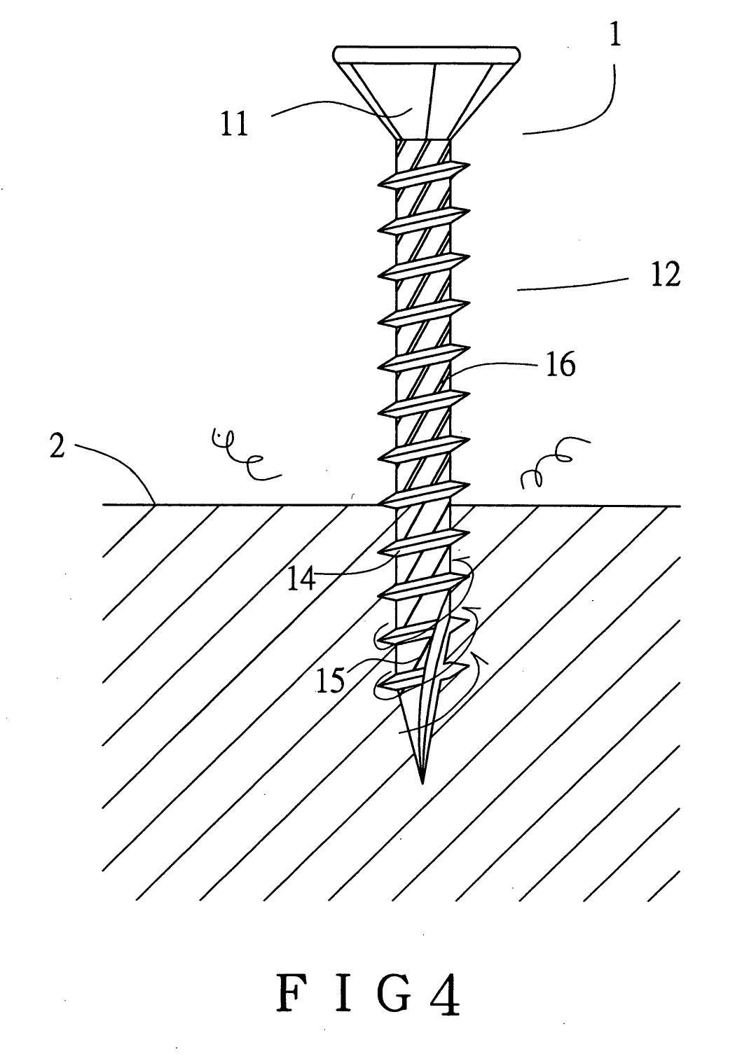

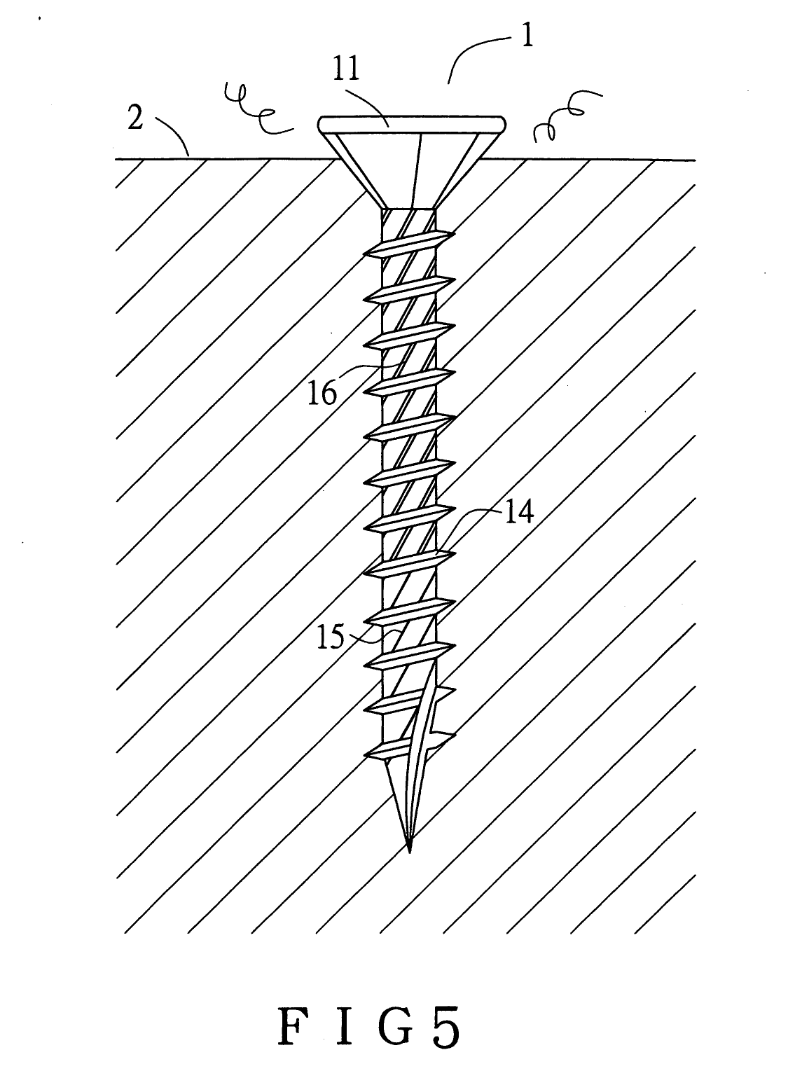

Referring to FIGS. 4 and 5, when screwing the screw I into an object 3, such as a wooden object, the tip end 13 easily enters into the object 3 and the spiral threads 14 cut the fibers of the object 3 and the at least one cutting groove 131 cooperated with assists the first section 121 of the shank 12 to enter into the object 3. The cutting edges of the cutting ridges 15 cut the fibers of the object 3 and guide the debris out from the object 3. The second section 122 is then entered into the object 3, the grooves 16 receive the debris of the object 3 so that the object 3 will not be broken by the debris. By the specific structure of the screw 1, the screw 1 can be easily entered into the object and the debris is well arranged during screwing.

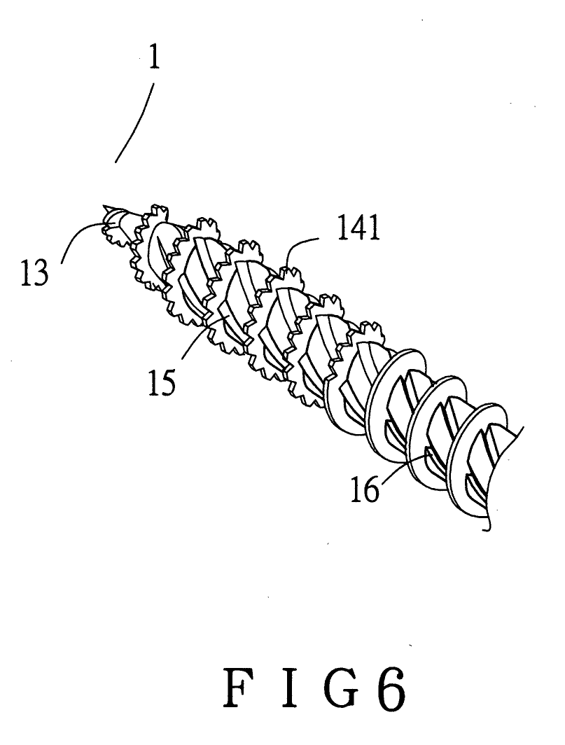

As shown in FIG. 6, another embodiment of the screw 1 is disclosed wherein the spiral threads 14 of the first section 121 include a plurality of cutting projections 141 which project radially from the spiral threads 14 so as to cut the fibers of the object 3 more efficiently.

While we have shown and described the embodiment in accordance with the present invention, it should be clear to those skilled in the art that further embodiments may be made without departing from the scope of the present invention.

1. A screw comprising:
a head having a shank connected to the head, and
a tip being defined on an end of the shank and located opposite to the head,
the shank including a first section and a second section,
wherein a plurality of spiral threads are circumferentially formed continuously about the outer periphery of the first and second section of the shank
the second section including the head further having a plurality of grooves formed helically about the second section,
the first section including the tip further having a plurality of cutting ridges extending helically about the outer periphery of the first section, whereby material cut by said cutting ridges is displaced into said grooves.

2. The screw as claimed in claim 1, wherein the cutting ridges each are an inverted V-shaped ridges.

3. The screw as claimed in claim 1, wherein the cutting ridges are tilted relative to an axis of the shank.

4. The screw as claimed in claim 1, wherein the cutting ridges are located between the spiral threads.

5. The screw as claimed in claim 1, wherein the grooves each are a V-shaped groove.

6. The screw as claimed in claim 1, wherein the grooves are tilted relative to an axis of the shank.

7. The screw as claimed in claim 1, wherein the grooves are located between the spiral threads.

8. The screw as claimed in claim 1, wherein at least one cutting groove is defined in an outer periphery of the tip end.

9. The screw as claimed in claim 1, wherein the spiral threads of the first section include a plurality of cutting projections.

10. A screw comprising:
a head having a shank connected to the head,
a tip being defined on an end of the shank and located opposite to the head, and
at least one cutting groove defined in an outer periphery of the tip end,
the shank including a first section and a second section,
wherein a plurality of spiral threads are circumferentially formed continuously about the outer periphery of the first and second section of the shank
the second section including the head further having a plurality of grooves formed helically about the second section,
the first section including the tip further having a plurality of cutting ridges extending helically about the outer periphery of the first section,
whereby material cut by said cutting ridges is displaced into said grooves.
